(19) United States
(12) Patent Application Publication
(10) Pub. No.: US 2018/0189554 A1
(43) Pub. Date: Jul. 5, 2018

(54) SYSTEMS AND METHODS TO PRESENT REACTIONS TO MEDIA CONTENT IN A VIRTUAL ENVIRONMENT

(71) Applicant: Facebook, Inc., Menlo Park, CA (US)

(72) Inventors: Charles Matthew Sutton, San Francisco, CA (US); Cliff Warren, San Francisco, CA (US); Gabriel Valdivia, San Francisco, CA (US)

(21) Appl. No.: 15/396,430

(22) Filed: Dec. 31, 2016

(51) Int. Cl. G06K 9/00; G06T 13/40; G06T 13/80; G06F 3/01; G06T 19/00; G06T 11/60

(52) U.S. Cl. CPC G06K 9/00315; G06T 13/40; G06T 11/60; G06F 3/011; G06T 19/006; G06T 13/80

(57) ABSTRACT

Systems, methods, and non-transitory computer readable media are configured to receive a recording of an expression of a content provider in response to a digital environment. The expression can be based on at least one of gestures, body movement, speech, and sounds of the content provider. An animation can be based on the recording. A reaction based on the animation can be presented to a user in the digital environment.

### FIELD OF THE INVENTION

The present technology relates to virtual environments. More particularly, the present technology relates to techniques for presenting reactions to media content in virtual environments.

### BACKGROUND

Users often utilize computing devices for a wide variety of purposes. Users can use their computing devices to, for example, interact with one another, access media content, share media content, and create media content. In some cases, media content can be provided by users of a social networking system. The media content can include one or a combination of, for example, text, images, videos, and audio. The media content may be published to the social networking system for consumption by others.

Under conventional approaches, media content provided through a social networking system can be accessed by users of the social networking system in various manners. In some cases, various media content can be provided to a user based on selections of the user or interests of the user as determined by the social networking system. In some instances, the user can provide information in response to media content accessed by the user.

### SUMMARY

Various embodiments of the present technology can include systems, methods, and non-transitory computer readable media configured to receive a recording of an expression of a content provider in response to a digital environment. The expression can be based on at least one of gestures, body movement, speech, and sounds of the content provider. An animation can be created based on the recording. A reaction based on the animation can be presented to a user in the digital environment.

In some embodiments, the animation can comprise at least one of a coin or an avatar exhibiting motion that mirrors the expression of the content provider.

In some embodiments, the coin can comprise an identifying picture of the content provider and the avatar can comprise a generic sketch of at least a portion of a human figure.

In some embodiments, a form of the reaction to be presented to the user can be determined based on a type of the digital environment.

In some embodiments, the reaction can be associated with a time stamp relating to a portion of media content providing the digital environment. Play back of the reaction to the user can be automatically initiated in response to the portion of the media content being presented to the user.

In some embodiments, a plurality of reactions associated with a scene in the digital environment can be indicated to the user for selection by the user in response to the scene being presented to the user.

In some embodiments, a plurality of reactions can be ranked for potential presentation to the user in the digital environment. The plurality of reactions can be presented in rank order to the user.

In some embodiments, the digital environment can comprise at least one of a virtual reality (VR) environment, an augmented reality (AR) environment, or a mixed reality (MR) environment.

In some embodiments, the digital environment can be provided through media content presented through an interface of a computing device, the media content comprising at least one of a panoramic photo, a 360 photo, a photo sphere, a 360 video, a three-dimensional (3D) simulation, or a 3D animation.

In some embodiments, the digital environment can be provided through a viewfinder of a computing device.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates a system including an example content provision module, according to an embodiment of the present technology.

FIG. 2 illustrates an example reactions module, according to an embodiment of the present technology.

FIG. 3A illustrates an example first scenario, according to an embodiment of the present technology.

FIG. 3B illustrates an example second scenario, according to an embodiment of the present technology.

FIG. 4 illustrates an example first method, according to an embodiment of the present technology.

FIG. 5 illustrates an example second method, according to an embodiment of the present technology.

FIG. 6 illustrates a network diagram of an example system that can be utilized in various scenarios, according to an embodiment of the present technology.

FIG. 7 illustrates an example of a computer system that can be utilized in various scenarios, according to an embodiment of the present technology.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Animated Reactions in a Virtual Reality Environment

As mentioned, users often utilize computing devices for a wide variety of purposes. Users can use their computing devices to, for example, interact with one another, access media content, share media content, and create media content. In some cases, media content can be provided by users of a social networking system. The media content can include one or a combination of, for example, text, images, videos, and audio. The media content may be published to the social networking system for consumption by others.

Under conventional approaches, media content provided through a social networking system can be accessed by users of the social networking system in various manners. In some cases, various media content can be provided to a user based on selections of the user or interests of the user as determined by the social networking system. In some instances, the social networking system can present media content for the user in support of a digital environment. A digital environment can include any experience or environment provided to a user in which the user can access content and otherwise interact. In many instances, a content provider can be permitted to provide a response to accessed media content. In conventional approaches, the content provider can provide a response to accessed media content by posting a text-based message, such as a comment. While to some degree it can be informative, a text-based message often fails to convey the full meaning and sentiment intended by the content provider who authored it. As a related matter, a text-based message often fails to generate interest or enthusiasm of other users who have viewed it that is sufficient to engender full discussion about the media content. Accordingly, communications about media content can be undesirably muted in the social networking system.

An improved approach rooted in computer technology overcomes the foregoing and other disadvantages associated with conventional approaches specifically arising in the realm of computer technology. Systems, methods, and computer readable media of the present technology can allow a user of a social networking system, such as a content provider, to provide a reaction to a digital environment accessed by the content provider. The digital environment can be presented through media content. To create a reaction, the content provider can record his or her gestures, speech, body movement, and other expression in response to the media content. For example, the expression of the user can be recorded by a camera, a microphone, sensors, or other equipment through which the content provider can interact in the digital environment. Contextual data, such as a time stamp relating to a portion of the media content to which the reaction relates, can be associated with the reaction. In addition, the content provider can specify access rights to restrict access to the reaction to designated users. A user of the social networking system can potentially access the media content. User interactions with the media content can be monitored. When it is determined that the user has accessed the portion of the media content associated with the reaction, the reaction can be provided to the user if the user enjoys permission to access the reaction based on the access rights. In some instances, at or around the time the portion of the media content to which the reaction relates is provided to the user, the user can be automatically provided with the reaction or an option to access the reaction. The reaction can be presented as an overlay in the digital environment. The reaction can be provided in different forms. For example, the reaction can be presented as a moving “coin” that includes an image of a body portion of the content provider, such as a face. Movement of the coin can be animated to reflect the expression of the content provider when the reaction was created. As another example, the reaction can be presented as an avatar whose animated movements reflect the expression of the content provider when the reaction was created. The form of the reaction can be selectively determined based on a type of the digital environment through which the reaction is to be presented. More details regarding the present technology are described herein.

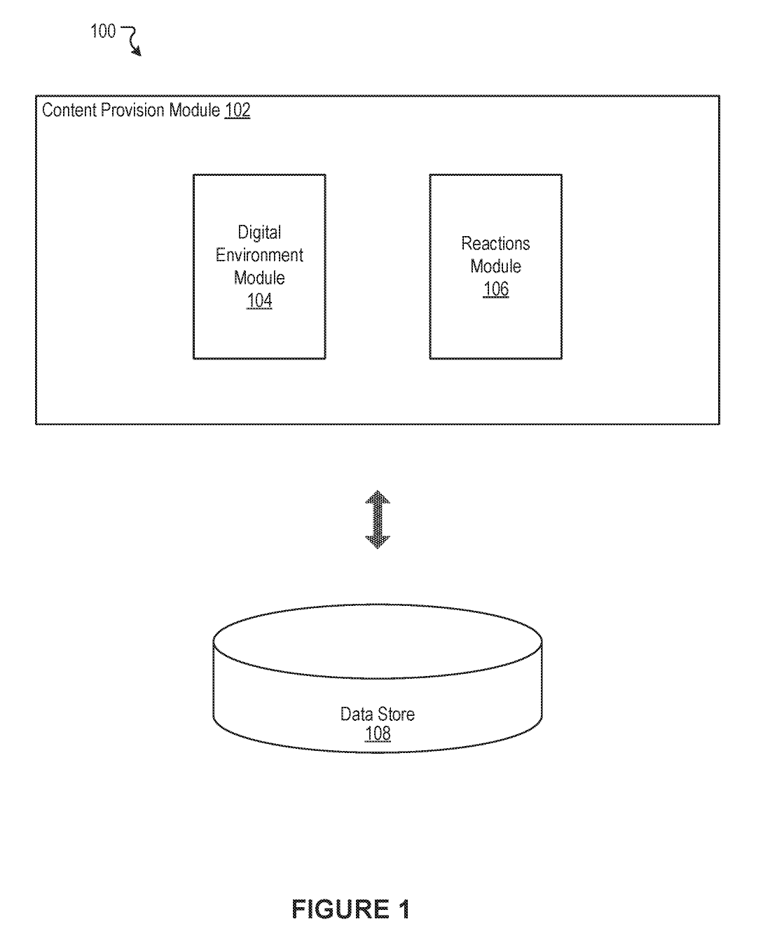

FIG. 1 illustrates an example system 100 including an example content provision module 102 configured to provide reactions in a digital environment, according to an embodiment of the present technology. The digital environment can be presented through media content. The content provision module 102 can allow a content provider to create and record reactions for presentation to users in a digital environment. A reaction can constitute a response to media content through which the digital environment is provided that conveys meaning and sentiment of the content provider through, for example, verbal communication and body language. As used herein, a reaction can include a reflection of gestures, body movement, speech, sounds, and any other types of expression of a content provider in response to the media content. The content provision module 102 can allow a user experiencing the digital environment to access reactions in the digital environment. The content provision module 102 can include a digital environment module 104 and a reactions module 106. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the content provision module 102 can be implemented in any suitable combinations.

The digital environment module 104 can provide a digital environment for a user. As used herein, a digital environment can include any medium, channel, platform, experience, or surrounding through which a content provider or a user, as appropriate, can create, configure, access, manage, or otherwise interact with reactions. In some embodiments, a digital environment can be provided to a content provider or a user through an interface of a computing device associated with the content provider or the user. The interface can include, for example, a desktop computer, a touchscreen of mobile device, a viewport mounted in headgear, a camera view or viewfinder of a mobile device, and the like. The content provider or the user can interact through the interface in the digital environment by appropriate user inputs and commands, such as mouse clicks, touch gestures, controller commands, body gestures, voice commands, etc. In some embodiments, a digital environment can include, for example, a two dimensional (2D) environment, a virtual reality (VR) environment, an augmented reality (AR) environment, a mixed reality (MR) environment, or other types of digital environments. In some embodiments, a digital environment can be provided through media content presented through an interface. In some embodiments, equipment through which a content provider or a user can interact in a digital environment can be in whole or in part included in or implemented by a user device 610, as discussed in more detail herein.

The media content through which a digital environment can be presented can be any suitable type of media content. The media content can include, for example, 2D images, 2D video, panoramic photos, 360 photos, photo spheres, 360 (or spherical) videos, three-dimensional (3D) simulations, 3D animations, and the like. The media content also can include, for example, a combination of different types of media content. For example, the media content can include any content that in whole or in part reflects 360 degree views or presents 3D content. In one instance, the media content can include a 360 photo or a 360 video that captures a 360 degree view of a scene. In another instance, the media content can include virtual reality (VR) content through which 3D environments can be presented to the user. As used herein, media content also includes presentation of environmental surroundings through a camera view or viewfinder of a camera or other device. 360 or spherical videos are referenced herein for ease of illustration. However, in various embodiments, the present technology can be adapted for any type of media content supportive of an immersive user experience including, for example, half sphere videos (e.g., 180 degree videos), arbitrary partial sphere videos, 225 degree videos, 3D 360 videos, to name some examples. In various embodiments, the present technology described herein can be adapted for any media content that partially or wholly encompasses (or surrounds) a viewer (or user). Moreover, such media content need not be limited to, for example, videos that are formatted using a spherical shape but may also be applied to immersive media content (e.g., videos) formatted using other shapes including, for example, cubes, pyramids, and other shape representations of a video recorded three dimensional world.

The reactions module 106 can allow a content provider to create a reaction to a digital environment for access by a user. The content provider can record a reaction in response to media content, or a portion of the media content, through which the digital environment is presented. As used herein, a portion of media content can include, for example, a scene, segment, component, element, theme, concept, or other selection of or in the media content. The reaction can convey an expression of the content provider through, for example, verbal communications and body movement in response to the portion of the media content. The content provider can specify access rights for the reaction. When a user accesses the portion of media content associated with the reaction, the user can be provided access to the reaction based on the access rights. A form of the reaction presented to the user can be based on a type of digital environment in which the user is interacting. As some examples, the reaction can be presented as an animated coin or an animated avatar that mirrors the recorded expression of the content provider. Functionality of the reactions module 106 is described in more detail herein.

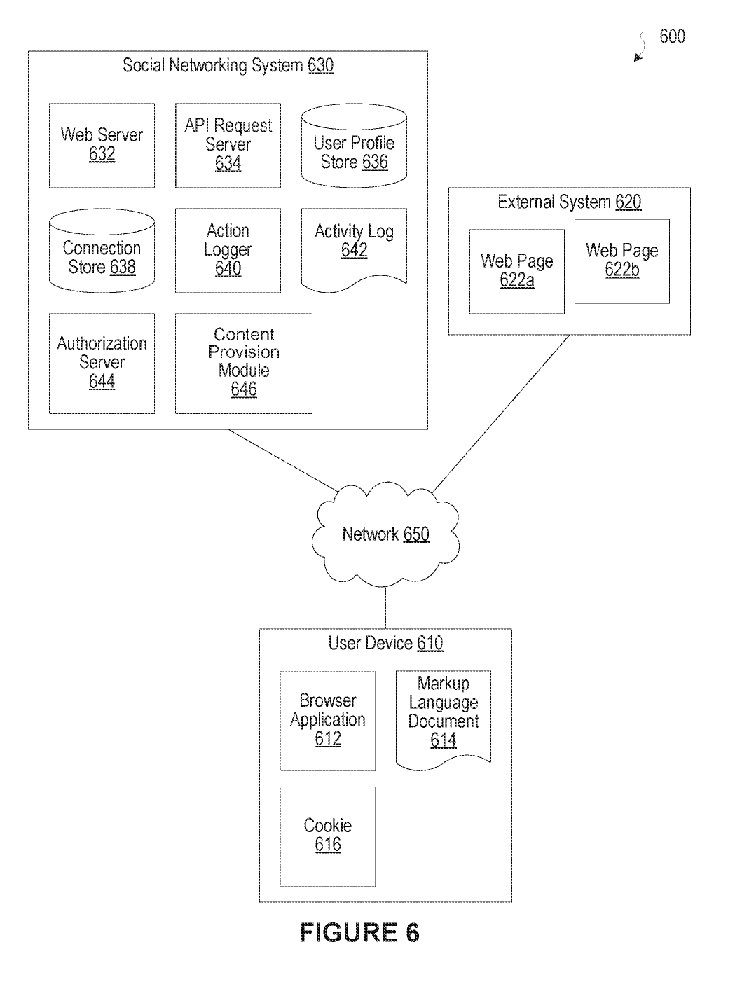

In some embodiments, the content provision module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the content provision module 102 can be, in part or in whole, implemented as software running on one or more computing devices or systems, such as on a server or a client computing device. For example, the content provision module 102 can be, in part or in whole, implemented within or configured to operate in conjunction or be integrated with a social networking system (or service), such as a social networking system 630 of FIG. 6. As another example, the content provision module 102 can be implemented as or within a dedicated application (e.g., app), a program, or an applet running on a user computing device or client computing system. In some instances, the content provision module 102 can be, in part or in whole, implemented within or configured to operate in conjunction or be integrated with client computing device, such as a user device 610 of FIG. 6. It should be understood that many variations are possible.

The system 100 can include a data store 108 configured to store and maintain various types of data, such as the data relating to support of and operation of the content provision module 102. The data store 108 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the content provision module 102 can be configured to communicate and/or operate with the data store 108.

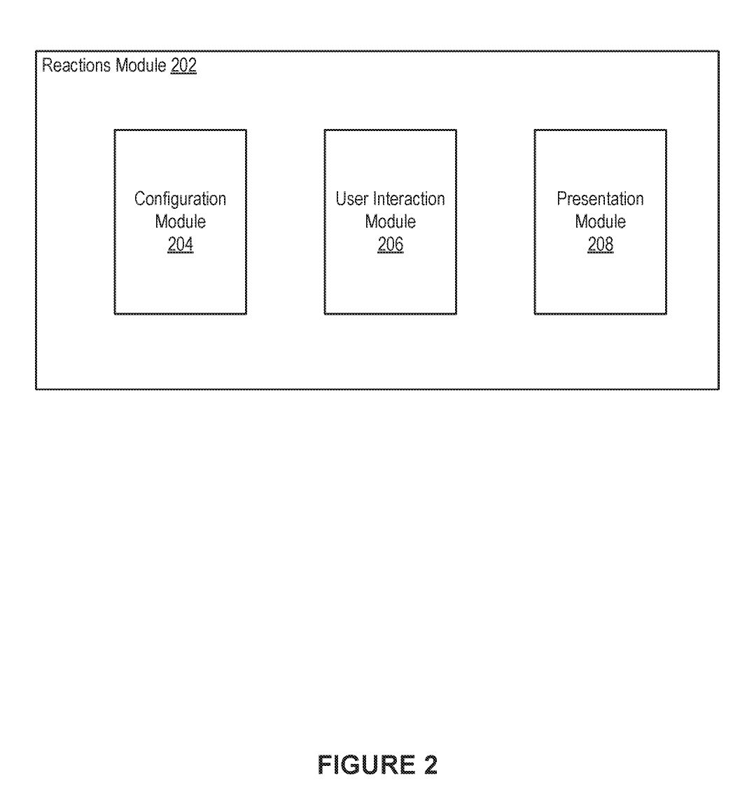

FIG. 2 illustrates an example reactions module 202, according to an embodiment of the present technology. In some embodiments, the reactions module 106 of FIG. 1 can be implemented with the reactions module 202. The reactions module 202 can include a configuration module 204, a user interaction module 206, and a presentation module 208.

The configuration module 204 can allow a content provider to configure and create a reaction to media content, or a portion thereof, for presentation in a digital environment. The configuration module 204 can provide an option through an interface for the content provider to create a reaction. In some embodiments, the option can be provided as a selectable element of the interface. When the content provider selects the element, a recording of the content provider in response to the portion of the media content can be performed. In some embodiments, the recording can have a predetermined time duration (e.g., 5 seconds, 10 seconds, 30 seconds, etc.). In other embodiments, the recording can have a time duration selected by the content provider. The recording can proceed as a countdown displayed to the content provider through the interface during which the recording should be completed. The content provider can record his or her gestures, body movement, speech, sounds, and other expression in response to the portion of the media content. For example, the content provider can speak and move to convey his or her expression for the recording. The expression of the content provider can be recorded by a camera, a microphone, sensors, or other equipment. For example, the expression can be recorded by a “selfie” camera and a microphone of a computing device providing an interface for presenting media content to a content provider. As another example, the expression can be recorded by a camera, a microphone, or other monitoring equipment that can capture expression of a content provider through sensors attached or adjacent to the body of the content provider. The recordings can capture some or all of the body movement of the content provider, sound of the content provider, or both. For example, the recordings can capture only facial gestures and head movements of the content provider along with audio of the content provider. As another example, the recordings can capture all of the body movements of the content provider, including movement of the hands, arms, feet, legs, etc., along with audio of the content provider.

A content provider can record any type of expression as a reaction in response to media content or a portion thereof. As just one example, to reflect or convey a sense or sentiment of happiness, a content provider can sing with elation while performing a spirited dance to constitute his or her expression in response to a portion of media content. As another example, to reflect or convey a serious observation, remark, comment, or other information about a portion of media content, a content provider can speak with a serious tone and gesture emphatically with his or her hands. As yet another example, a content provider can select an option not to record video and only permit recording of audio. Likewise, a content provider can select an option not to record audio and only permit recording of video. Many different expressions are possible. Upon conclusion of the recording of the expression, a reaction in response to media content, or a portion thereof, can be created for potential presentation to users who later access the media content, as discussed in more detail herein.

The configuration module 204 can manage contextual information relating to a reaction. In some embodiments, a time stamp of a reaction in relation to associated media content can be determined and logged. For example, if a reaction was created by a content provider in response to a portion of media content at a point or window of time during presentation of the media content, the reaction can be associated with a time stamp relating to the point or the window of time. As discussed in more detail herein, when a user later accesses the portion of the media content, a reaction can be provided to the user based on the time stamp.

The configuration module 204 can allow a content provider to associate a created reaction with a concept reflected in a digital environment. A concept can include any item, element, theme, or other component reflected in or depicted by media content. In some embodiments, the configuration module 204 can prompt the content provider to select a concept to associate with the reaction. In some embodiments, the content provider can identify the selected concept by an appropriate user interaction in the digital environment. Access to the reaction can be provided to a user in the digital environment when the attention of the user is directed at the selected concept, as discussed in more detail herein.

The configuration module 204 can allow a content provider to specify access rights designating users who are permitted to view a reaction created by the content provider. In some embodiments, the configuration module 204 can prompt the content provider through an interface to specify the access rights. For example, the content provider can identify one or more users who are permitted access based on their identifications (e.g., user IDs, names, etc.). In another example, the content provider can identify users by their degree of connection to the content provider in a social networking system. For instance, the content provider can identify users in a social networking system who are within a selected number of degrees of connection from the content provider as having permission to view the reaction. In some embodiments, the content provider can identify users who do not have permission to view the reaction and all other users not so identified can have permission to view the reaction. Many variations are possible.

The user interaction module 206 can receive detected information reflecting users and their interactions in a digital environment. The detected information can be provided in real time (or near real time) by computing devices, sensors, or other equipment that is capable of detecting and monitoring actions of users in the digital environment. For example, the detected information can include information regarding timing of media content presented to a user. As another example, the detected information can include information regarding an interaction directed by a user at a particular concept depicted in the digital environment. Such interaction can include, for example, a gaze gesture by the user directed at the concept as detected by, for example, sensors that can detect and monitor eye movement of the user.

The presentation module 208 can selectively present reactions to users in a digital environment. In some embodiments, a reaction can be potentially provided to a user based on contextual information associated with the reaction. For example, if an elapsed time of presentation of media content to a user matches or coincides with a time stamp of a reaction in relation to the media content, the reaction can be provided to the user at the same time that relevant media content is being provided to the user. In other words, the user can access a portion of media content and, at the same time, can timely access a reaction created in response to the portion of the media content. In some embodiments, the provision of a reaction to a user can be a predetermined time before or a predetermined time after presentation of a portion of media content to which the reaction responds. In some embodiments, if an interaction of a user, such as a gaze gesture, in a digital environment is directed at a concept associated with a reaction, the presentation module 208 can determine that the reaction can be indicated and played back to the user. In this way, provision of the reaction can be relevant to the focus of the user on the concept as indicated by his or her interactions. If an interaction of a user is not directed at the concept, the presentation module 208 can determine that the reaction should not be presented to the user. In some embodiments, before provision of a reaction to a user, the presentation module 208 can check to see if the user can be provided with the reaction based on access rights. If the access rights permit the user to access the reaction, the reaction can be provided to the user. If the access rights do not permit the user to access the reaction, the reaction will not be provided to the user.

The presentation module 208 can present a reaction in a variety of forms in a digital environment. In some embodiments, a reaction can be provided as an animated coin for presentation to a user. The coin can be an object having a substantially circular or other shape. The coin can include an image of a content provider of the reaction. The image can be a profile picture or other picture associated with the content provider. The coin and image therein can be animated to include motion that mirrors or follows body movements or movements of a particular body part (e.g., head) of a content provider during recording of expression constituting a reaction. The animated coin can be presented as an overlay in a digital environment. The animated coin can be presented in 2D or 3D based on its suitability for a type of the digital environment in which it will appear, as discussed herein. The coin can be animated for any type of movement, such as any type of translational and rotational motion. The animation of the coin also can include audio recorded as part of the expression of the content provider recorded to constitute the reaction. For example, if recorded expression of a content provider includes head turning by the content provider, the coin can be animated to include turning to mirror the head turning by the content provider. As another example, if recorded expression of a content provider includes jumping up and down by the content provider, the coin can be animated to include moving up and down to mirror the jumping by the content provider. As yet another example, if recorded expression of a content provider is audio information only, the coin can be animated to reflect signal patterns in the audio information. For instance, the coin can be animated to include moving (e.g., spinning, flipping, undulating, etc.) in synchronicity with points in the audio information exhibiting relatively high signal amplitudes. In some embodiments, animation of the coin can include replay of video, audio, or both recorded from a content provider.

In some embodiments, a reaction can be provided as an avatar representing a content provider who created the reaction. The avatar can be presented as ghost-like figure without depiction of physical features capable of identifying the content provider. For example, the avatar can be presented as a generic sketch of a head and torso of a human figure with generic facial features that do not depict the specific facial features of the content provider. As another example, the avatar can be presented as a generic sketch of a human figure displaying a head with generic facial features, body, arms, and legs. As yet another example, the avatar can be presented as a realistic depiction of the content provider (e.g., an image of the face and head of the content provider) that reflects actual physical characteristics of the content provider. The animated avatar can be presented as an overlay in a digital environment. The animated avatar can be presented in 2D or 3D based on its suitability for a type of the digital environment in which it will appear, as discussed herein. Like the coin, the avatar can be animated to include mirroring or following the body movements or movements of a particular body part (e.g., head) of the content provider during recording of an expression constituting a reaction. For example, if recorded expression of a content provider involved speaking and dancing, the avatar can be animated to speak and dance in a manner similar to the recorded expression of the content provider. As another example, if recorded expression of a content provider involved singing and gesturing, the avatar can be animated to sing and gesture in a manner similar to the recorded expression of the content provider. The avatar can be animated for any type of movement. Many variations are possible.

The presentation module 208 can select a form of a reaction for presentation to a user based on a variety of considerations. In some embodiments, the presentation module 208 can select a form of a reaction based on a type of digital environment presented to a user. For example, when a digital environment is a 2D environment, the presentation module 208 can select a reaction in the form of a coin. In this example, a reaction in the form of a coin in some cases may be better suited to a 2D environment. As another example, when a digital environment is a VR environment, the presentation module 208 can select a reaction in the form of an avatar. In this regard, an animated avatar reflecting dynamic movement in 3D may better optimize user experience in a VR environment. In some embodiments, the presentation module 208 can select a form of reaction based on availability of a form of reaction. For example, if expression of a content provider did not include body movements, or if no camera or other sensors were available to record body movements of the content provider, the presentation module 208 can determine that the reaction can be presented as a coin instead of an avatar. In some embodiments, a form of reaction can be based on a product or feature in which the reaction is to be presented. For example, if a reaction is to be provided in media content relating to stories in a news feed, the presentation module 208 can select a coin as a default form of the reaction. Many variations are possible.

The presentation module 208 can provide access to reactions in various modes of presentation. In some embodiments, the presentation module 208 can implement a presentation mode in which reactions are automatically indicated for a user accessing media content. For example, as media content is presented to a user, reactions relevant to portions of the media content are automatically presented to the user as the user accesses the portions of the media content. For instance, assume that a first reaction is associated with a first scene in media content and a second reaction and a third reaction are associated with a second scene in the media content. In this instance, the media content can provide a digital environment, such as a VR environment. As a user accesses or views the media content, the first reaction can be automatically indicated to the user when the user accesses the first scene. The indication of the first reaction, which can be a coin or an avatar presented in the digital environment, can be a selectable overlay in the digital environment or the media content. After selection of the first reaction, the first reaction can be executed (e.g., played back) so that the animation associated with the first reaction is performed in the digital environment. After execution of the first reaction or after presentation of the first scene, the first reaction can disappear from the digital environment. As the user continues to view the media content, the second reaction and the third reaction can be automatically indicated to the user when the user accesses the second scene. Likewise, the indication of the reactions can be selectable overlays in the digital environment. After selection of one or both of the second reaction and the third reaction, the reactions can be executed (e.g., played back) so that the animations associated with the reactions are performed in the digital environment at the same, overlapping, or different times. Thereafter, the reactions can disappear. The foregoing description can be applied to indication and execution of any number of reactions. In some instances, the user can select a reaction to cause play back of the reaction as presentation of the media content to the user continues simultaneously. In some instances, play back of a reaction can be automatically initiated when an elapsed time of presentation of associated media content matches a timestamp of the reaction.

In some embodiments, the presentation module 208 can limit reactions presented to a user. In some embodiments, when a plurality of reactions for potential presentation to a user satisfies (e.g., is equal to or greater than) a threshold number of reactions, only the threshold number of reactions can be presented to a user. In some embodiments, reactions can be ranked and presented to a user in rank order. For example, a reaction that is created by a content provider having relatively higher affinity with a user to whom the reaction is potentially presented can be ranked higher than a reaction created by a content provider having relatively lower affinity. As another example, a reaction determined to relate to a concept having a relatively higher level of relevance or interest to a user can be ranked higher than a reaction not so determined.

In some embodiments, the presentation module 208 can allow creation of reactions that are layered or cascaded. In this regard, a content provider can create a first reaction. The first reaction can be accessed by a user. The user, in turn, can create a second reaction in response to the first reaction. Likewise, a third reaction can be created by the content provider or another content provider in response to the second reaction, and so on. The present technology can provide any number of layers of reactions to support communications among content providers and users.

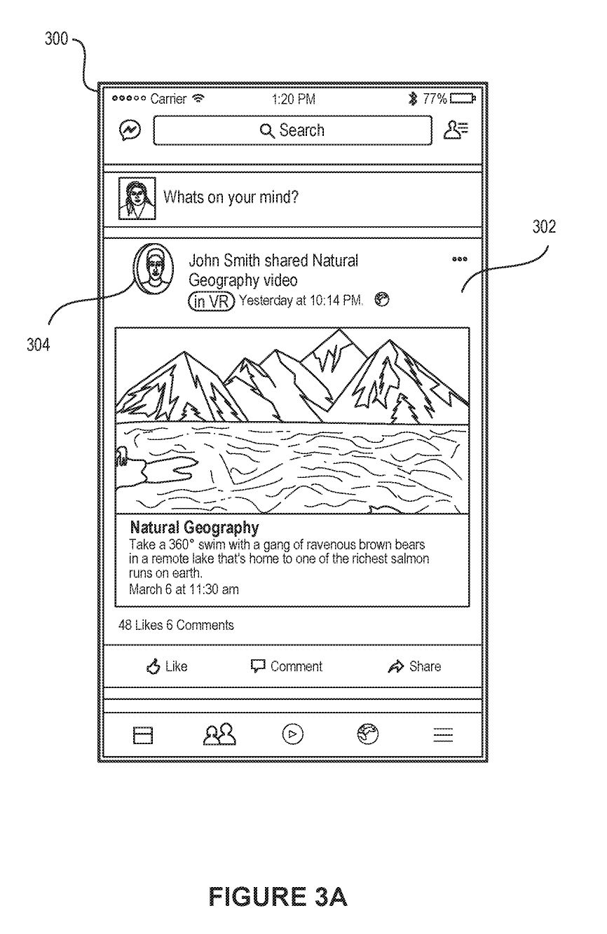

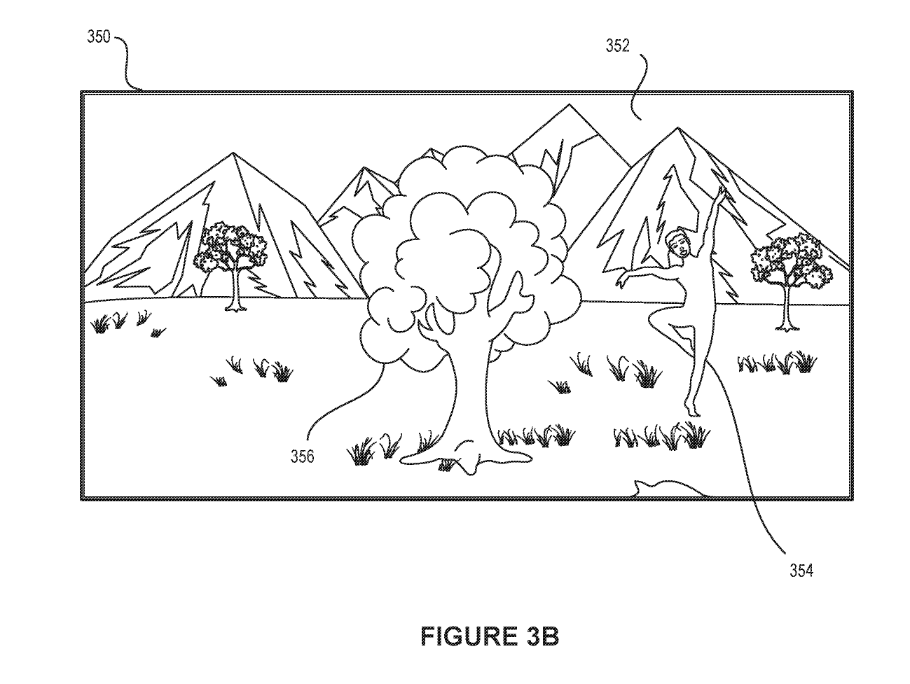

FIG. 3A illustrates an example first scenario, according to an embodiment of the present technology. As shown in FIG. 3A, an interface 300 presented through a computing device presents a digital environment to a user associated with the computing device. The digital environment can be provided through media content 302. As shown, the media content 302 is associated with a story in a news feed of the user that includes a 360 video. A reaction 304 is overlaid in the media content 302. In the example shown, the form of the reaction 304 is a coin. The coin includes an image of a content provider. The reaction 304 was previously created by the content provider in response to a portion of the media content 302. The reaction 304 can be associated with a time stamp in relation to the portion of the media content 302. The reaction 304 is indicated to the user (i.e., is presented to the user) because the user is permitted to experience the reaction 304 based on access rights previously specified by the content provider.

In some instances, play back of the reaction 304 can be initiated by a command applied by the user to the interface 300. In other instances, play back of the reaction 304 can be initiated automatically when the time of play back of the media content 302 matches the time stamp of the reaction 304. Play back of the reaction 304 allows the user to be presented with animation of the coin. The animation of the coin can exhibit motion that mirrors expression of the content provider when the expression was recorded to create the reaction 304. In the example shown, the animation of the coin includes spinning and moving higher to reflect spinning and ascending motion of the content provider when the expression of the content provider was recorded. The animation of the coin also can include play back of sounds of the content provider that were included in the recorded expression.

FIG. 3B illustrates an example second scenario, according to an embodiment of the present technology. As shown in FIG. 3B, an interface 350 implemented on equipment, such as a viewport in headgear, presents a digital environment to a user. As shown, the digital environment is a virtual reality (VR) environment. The digital environment can be provided through media content 352. As shown, the media content 352 can be a 3D scene provided by a 360 image, 360 video, or VR content, to name some examples. A reaction 354 is overlaid in the media content 352. The reaction 354 is associated with a concept 356 depicted in the media content 352. The reaction 354 was previously created by a content provider and associated with the concept 356. In the example shown, the form of the reaction 354 is an avatar. The avatar is a generic sketch of the human figure of the content provider. The user is presented with the reaction 354 based on access rights previously specified by the content provider.

As shown, play back of the reaction 354 can be initiated automatically when an interaction of the user is directed at the concept 356, as detected by sensors or equipment supportive of interactions in the VR environment. In other instances, play back of the reaction 354 can be initiated by a command applied by the user to the interface 350. Play back of the reaction 354 allows the user to experience animation of the avatar. The animation of the avatar can include motion that mirrors expression of the content provider when the expression was recorded to create the reaction 354. In the example shown, the avatar is singing and dancing to mirror singing and dancing of the content provider when the expression of the content provider was recorded. The animation of the avatar also can include play back of sounds of the content provider that were included in the recorded expression. After play back of the reaction 354, the reaction 354 can continue to be indicated for repeated play back or can disappear from the digital environment.

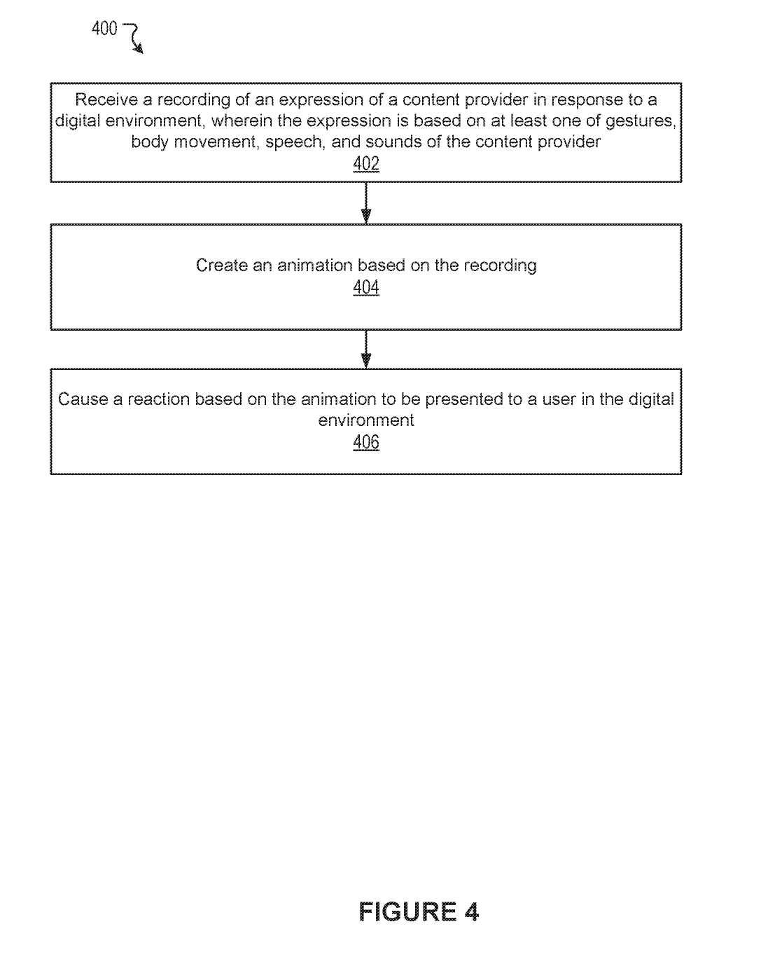

FIG. 4 illustrates a first example method 400 relating to presentation of a reaction in a digital environment, according to an embodiment of the present technology. It should be appreciated that there can be additional, fewer, or alternative steps performed in similar or alternative orders, or in parallel, in accordance with the various embodiments and features discussed herein unless otherwise stated.

At block 402, the method 400 can receive a recording of an expression of a content provider in response to a digital environment, wherein the expression is based on at least one of gestures, body movement, speech, and sounds of the content provider. At block 404, the method 400 can create an animation based on the recording. At block 404, the method 400 can cause a reaction based on the animation to be presented to a user in the digital environment. Other suitable techniques that incorporate various features and embodiments of the present technology are possible.

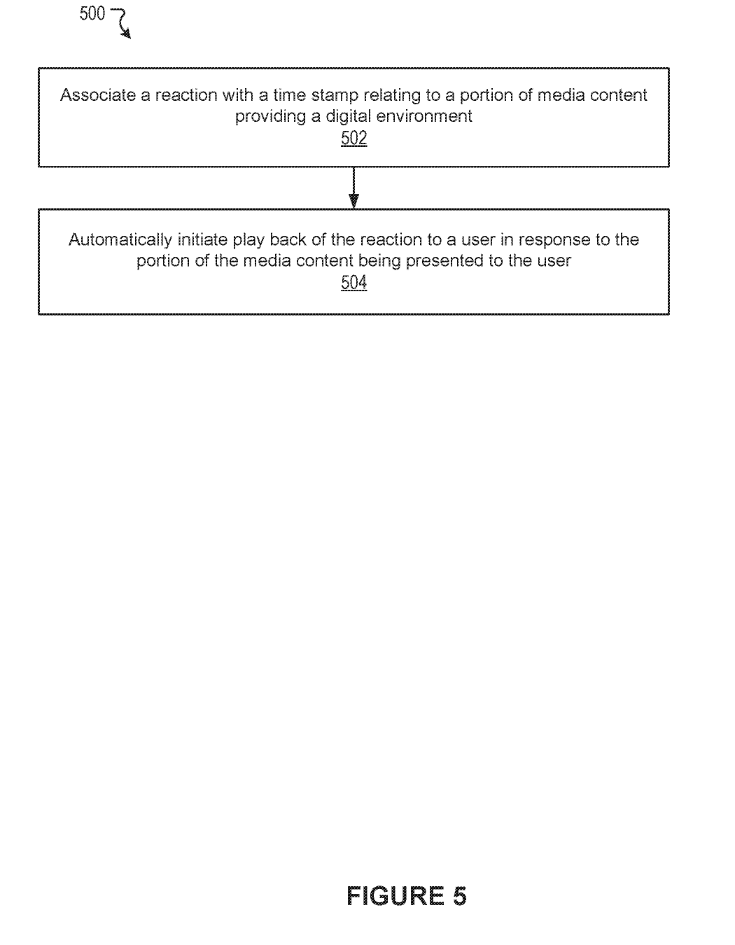

FIG. 5 illustrates a second example method 500 relating to presentation of a reaction in a digital environment, according to an embodiment of the present technology. It should be appreciated that there can be additional, fewer, or alternative steps performed in similar or alternative orders, or in parallel, in accordance with the various embodiments and features discussed herein unless otherwise stated.

At block 502, the method 500 can associate a reaction with a time stamp relating to a portion of media content providing a digital environment. At block 504, the method 500 can automatically initiate play back of the reaction to a user in response to the portion of the media content being presented to the user. Other suitable techniques that incorporate various features and embodiments of the present technology are possible.

It is contemplated that there can be many other uses, applications, features, possibilities, and variations associated with various embodiments of the present technology. For example, users can choose whether or not to opt-in to utilize the present technology. The present technology also can ensure that various privacy settings, preferences, and configurations are maintained and can prevent private information from being divulged. In another example, various embodiments of the present technology can learn, improve, and be refined over time.

### Social Networking System—Example Implementation

FIG. 6 illustrates a network diagram of an example system 600 that can be utilized in various scenarios, in accordance with an embodiment of the present technology. The system 600 includes one or more user devices 610, one or more external systems 620, a social networking system (or service) 630, and a network 655. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 655. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 655. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 655, which may comprise any combination of local area and/or wide area networks, using wired and/or wireless communication systems.

In one embodiment, the network 655 uses standard communications technologies and protocols. Thus, the network 655 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 655 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 655 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 655. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 655.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 655. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 655, and the API request server 634 receives the API request. The API request server 634 processes the request by calling an API associated with the API request to generate an appropriate response, which the API request server 634 communicates to the external system 620 via the network 655. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a content provision module 646. The content provision module 646 can be implemented with the content provision module 102, as discussed in more detail herein. In some embodiments, one or more functionalities of the content provision module 646 can be implemented in the user device 610.

### Hardware Implementation

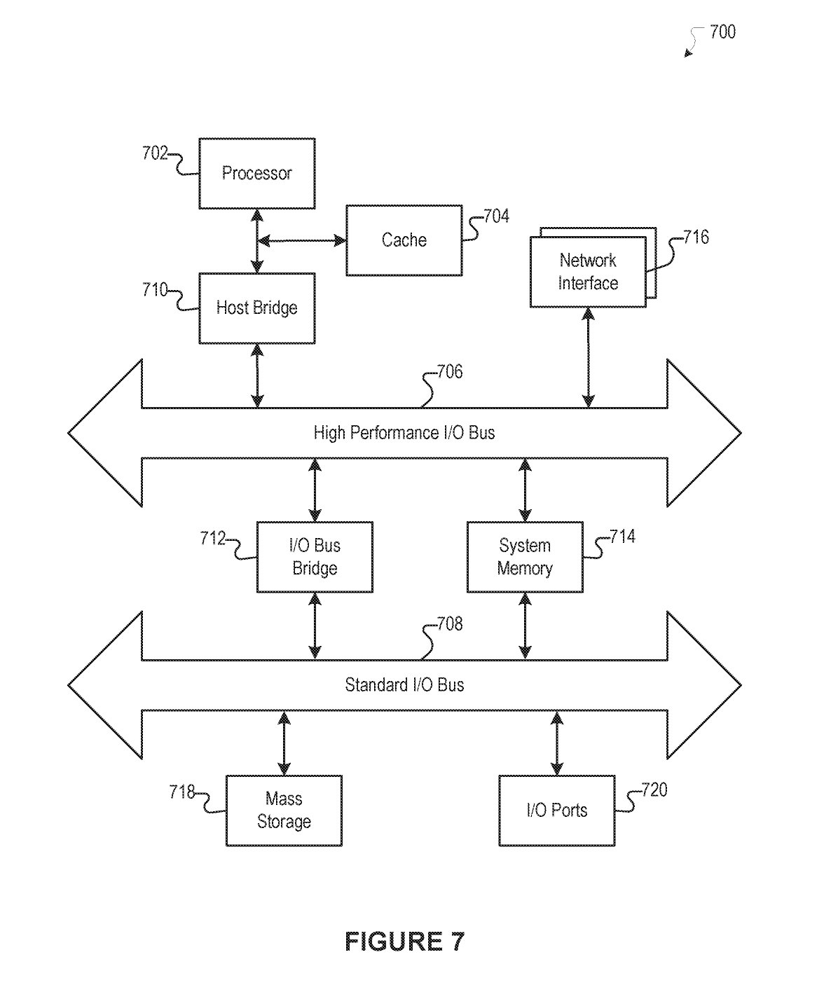

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the ×86-compatible processors manufactured by Intel Corporation of Santa Clara, Calif., and the ×86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by a computing system, a recording of an expression of a content provider in response to a digital environment, wherein the expression is based on at least one of gestures, body movement, speech, and sounds of the content provider;
creating, by the computing system, an animation based on the recording; and
causing, by the computing system, a reaction based on the animation to be presented to a user in the digital environment.

2. The computer-implemented method of claim 1, wherein the animation comprises at least one of a coin or an avatar exhibiting motion that mirrors the expression of the content provider.

3. The computer-implemented method of claim 2, wherein the coin comprises an identifying picture of the content provider and the avatar comprises a generic sketch of at least a portion of a human figure.

4. The computer-implemented method of claim 1, further comprising:
determining a form of the reaction to be presented to the user based on a type of the digital environment.

5. The computer-implemented method of claim 1, further comprising:
associating the reaction with a time stamp relating to a portion of media content providing the digital environment; and
automatically initiating play back of the reaction to the user in response to the portion of the media content being presented to the user.

6. The computer-implemented method of claim 1, wherein a plurality of reactions associated with a scene in the digital environment are indicated to the user for selection by the user in response to the scene being presented to the user.

7. The computer-implemented method of claim 1, further comprising:
ranking a plurality of reactions for potential presentation to the user in the digital environment; and
presenting the plurality of reactions in rank order to the user.

8. The computer-implemented method of claim 1, wherein the digital environment comprises at least one of a virtual reality (VR) environment, an augmented reality (AR) environment, or a mixed reality (MR) environment.

9. The computer-implemented method of claim 1, wherein the digital environment is provided through media content presented through an interface of a computing device, the media content comprising at least one of a panoramic photo, a 360 photo, a photo sphere, a 360 video, a three-dimensional (3D) simulation, or a 3D animation.

10. The computer-implemented method of claim 1, wherein the digital environment is provided through a viewfinder of a computing device.

11. A system comprising:
at least one processor; and
a memory storing instructions that, when executed by the at least one processor, cause the system to perform:
receiving a recording of an expression of a content provider in response to a digital environment, wherein the expression is based on at least one of gestures, body movement, speech, and sounds of the content provider;
creating an animation based on the recording; and
causing a reaction based on the animation to be presented to a user in the digital environment.

12. The system of claim 11, wherein the animation comprises at least one of a coin or an avatar exhibiting motion that mirrors the expression of the content provider.

13. The system of claim 12, wherein the coin comprises an identifying picture of the content provider and the avatar comprises a generic sketch of at least a portion of a human figure.

14. The system of claim 11, further comprising:
determining a form of the reaction to be presented to the user based on a type of the digital environment.

15. The system of claim 11, further comprising:
associating the reaction with a time stamp relating to a portion of media content providing the digital environment; and
automatically initiating play back of the reaction to the user in response to the portion of the media content being presented to the user.

16. A non-transitory computer-readable storage medium including instructions that, when executed by at least one processor of a computing system, cause the computing system to perform a method comprising:
receiving a recording of an expression of a content provider in response to a digital environment, wherein the expression is based on at least one of gestures, body movement, speech, and sounds of the content provider;
creating an animation based on the recording; and
causing a reaction based on the animation to be presented to a user in the digital environment.

17. The non-transitory computer-readable storage medium of claim 16, wherein the animation comprises at least one of a coin or an avatar exhibiting motion that mirrors the expression of the content provider.

18. The non-transitory computer-readable storage medium of claim 17, wherein the coin comprises an identifying picture of the content provider and the avatar comprises a generic sketch of at least a portion of a human figure.

19. The non-transitory computer-readable storage medium of claim 16, further comprising:
determining a form of the reaction to be presented to the user based on a type of the digital environment.

20. The non-transitory computer-readable storage medium of claim 16, further comprising:
associating the reaction with a time stamp relating to a portion of media content providing the digital environment; and
automatically initiating play back of the reaction to the user in response to the portion of the media content being presented to the user.
